(19) United States
(12) Patent Application Publication
(10) Pub. No.: US 2026/0212486 A1
(43) Pub. Date: Jul. 23, 2026

(54) METHOD FOR GENERATING ABNORMAL IMAGE BASED ON CONDITIONAL DIFFUSION MODEL, AND METHOD AND SYSTEM FOR TRAINING ARTIFICIAL INTELLIGENCE MODEL BASED ON THE SAME

(71) Applicant: LG MANAGEMENT DEVELOPMENT INSTITUTE CO., LTD., Seoul (KR)

(72) Inventors: Woo Hyung LIM, Seoul (KR); Ye Seul SIM, Seoul (KR); Hye Seung CHO, Seoul (KR); Su Hee YOON, Seoul (KR); Sang Hyu YOON, Seoul (KR); Sung Ik CHOI, Seoul (KR); Kyung Eun LEE, Seoul (KR)

(21) Appl. No.: 19/636,945

(22) Filed: Apr. 2, 2026

Related U.S. Application Data
(63) Continuation of application No. PCT/KR2025/008107, filed on Dec. 6, 2025.

(30) Foreign Application Priority Data
Jun. 27, 2024 (KR) 10-2024-0084856
Feb. 26, 2025 (KR) 10-2025-0025305

(51) Int. Cl. G06T 7/00; G06N 3/0475; G06N 3/063; G06N 3/08; G06T 7/12

(52) U.S. Cl. CPC G06T 7/0008; G06N 3/0475; G06N 3/063; G06N 3/08; G06T 7/12; G06T 2207/30148

(57) ABSTRACT

A method executed by a computer, the method includes: loading in-distribution inspection data stored in at least one memory; inputting the loaded in-distribution inspection data into at least one artificial intelligence model, and obtaining process-based noisy inspection data by noising the in-distribution inspection data up to a specific time-step; obtaining a semantic mask which is a mask specifying a semantic element for the in-distribution inspection data, and a nuisance mask which is a mask specifying a nuisance element for the in-distribution inspection data, from the noisy inspection data; generating out-of-distribution inspection data by applying selective data processing guidance configured to preserve the nuisance element and modify the semantic element based on the semantic mask and the nuisance mask; and outputting the out-of-distribution inspection data through at least one interface.

### CROSS REFERENCE TO RELATED APPLICATIONS

This application is a Bypass Continuation of International Patent Application No. PCT/KR2025/008107, filed on Jun. 12, 2025, which claims priority from and the benefit of Korean Patent Application Nos. 10-2024-0084856, filed on Jun. 27, 2024 and 10-2025-0025305, filed on Feb. 26, 2025, which is hereby incorporated by reference for all purposes as if fully set forth herein.

### BACKGROUND

### Field

Embodiments of the invention relate generally to a method for generating an abnormal image based on a conditional diffusion model and a method and system for training an artificial intelligence model on the basis of the same, and more particularly, to a method for generating an abnormal image based on a conditional diffusion model and a method and system for training an artificial intelligence model on the basis of the same, which generate an abnormal image whose nuisance elements are similar to those of a normal image and whose semantic elements differ from them, and which train an artificial intelligence model based on the generated virtual abnormal image.

### Discussion of the Background

Out-of-Distribution (OOD) detection is an important issue in which an artificial intelligence model accurately identifies inputs that do not belong to a distribution on which it is trained (hereinafter referred to as “In-Distribution (ID)”).

This technology is essential in various real-world applications such as medical diagnosis, autonomous driving, and manufacturing process monitoring, and may contribute to ensuring the reliability and safety of models.

Recently, a variety of studies based on the Outlier Exposure approach have been proposed, attempting to improve the ability to distinguish between normal data and abnormal data. However, existing anomaly detection methodologies face several major challenges.

First, many studies focus on modeling a normal distribution using only normal samples, and detecting anomalies by determining whether new inputs belong to this distribution. While this approach enables effective anomaly detection based on a thorough understanding of normal data, it is often difficult to obtain sufficient abnormal data (OOD samples) in real-world application environments. In particular, in certain domains, abnormal data is extremely rare, or its collection and labeling may require a lot of cost and time, thereby revealing limitations in practical applications.

In addition, recent attempts to synthesize virtual abnormal images using diffusion models have attracted attention. However, the existing pixel-level OOD synthesis methods still face unresolved issues. First, synthesis methods using existing diffusion models generate images that are too different from the in-distribution (ID), which may fail to effectively reflect subtle abnormal situations that can occur in real-world application environments. Second, such methods do not make proper use of nuisance elements such as background or texture, resulting in generated abnormal images that fail to capture subtle differences that could arise in situations similar to real ID data. Consequently, these limitations make it difficult in practice for anomaly detection models to distinguish OOD samples that are similar to ID data.

The above information disclosed in this Background section is only for understanding of the background of the inventive concepts, and, therefore, it may contain information that does not constitute prior art.

### SUMMARY

There is a growing need for methodologies that effectively generate abnormal data while leveraging normal data.

Embodiments of the invention provide methods for generating abnormal images based on a conditional diffusion model, and methods and systems for training an artificial intelligence model using the generated abnormal images. The methods generate abnormal images that preserve nuisance elements of normal images while modifying semantic elements, thereby enabling improved training of the artificial intelligence model.

Additional features of the inventive concepts will be set forth in the description which follows, and in part will be apparent from the description, or may be learned by practice of the inventive concepts.

According to one or more embodiments of the invention, a method executed by a computer, the method includes: loading, by at least one processor of the computer, in-distribution inspection data stored in at least one memory, wherein the inspection data includes multidimensional data obtained by photographing or measuring the state of a target object; inputting, by the at least one processor, the loaded in-distribution inspection data into at least one artificial intelligence model, and obtaining process-based noisy inspection data by noising the in-distribution inspection data up to a specific time-step, wherein the at least one artificial intelligence model includes at least one diffusion model, which is a generative model that learns probability distributions over a predetermined data space to generate data from random noise or to restore original data from noised data; obtaining, by the at least one processor, a semantic mask which is a mask specifying a semantic element for the in-distribution inspection data, and a nuisance mask which is a mask specifying a nuisance element for the in-distribution inspection data, from the noisy inspection data; generating, by the at least one processor, out-of-distribution inspection data by applying selective data processing guidance configured to preserve the nuisance element and modify the semantic element based on the semantic mask and the nuisance mask; and outputting, by the at least one processor, the out-of-distribution inspection data through at least one interface.

The step of obtaining noisy inspection data may include injecting the noise into the in-distribution inspection data up to the specific time-step.

The step of obtaining a semantic mask and a nuisance mask may include performing conditional diffusion to execute a reverse diffusion process according to a specific condition based on the noisy inspection data.

The step of obtaining a semantic mask and a nuisance mask may further include performing unconditional diffusion to execute the reverse diffusion process unconditionally based on the noisy inspection data.

The step of obtaining a semantic mask and a nuisance mask may further include calculating a conditional prediction value, which is a noise prediction value according to the conditional diffusion, and an unconditional prediction value, which is a noise prediction value according to the unconditional diffusion.

The step of obtaining a semantic mask and a nuisance mask may further include calculating a noise prediction error, which is the difference between the conditional prediction value and the unconditional prediction value.

The step of obtaining a semantic mask and a nuisance mask may further include generating the semantic mask based on pixels for which the absolute value of the noise prediction error belongs to a predetermined top N (>0) percent, and generating the nuisance mask based on pixels for which the absolute value of the noise prediction error belongs to a predetermined bottom M (>0) percent.

The step of generating out-of-distribution inspection data by applying the selective data processing guidance may include configuring a selective data processing guidance component, which is a component that specifies the manner of applying the selective data processing guidance to the reverse diffusion process of the at least one artificial intelligence model.

The selective data processing guidance component may include an original semantic removal component, which is a component that gradually removes the semantic element, a nuisance information preservation component, which is a component that preserves the nuisance element, and a new semantic addition component, which is a component that adds a new semantic element.

The new semantic addition component may add the new semantic element to a region except a region overlapping with the nuisance mask.

The step of configuring a selective data processing guidance component may include obtaining a selective data processing guidance integration component, which is a component that combines the original semantic removal component, the nuisance information preservation component, and the new semantic addition component into a single component.

The step of generating out-of-distribution inspection data by applying the selective data processing guidance may further include applying the selective data processing guidance integration component to the noise prediction value for each time-step in the reverse diffusion process.

The method may further include performing, by the at least one processor, training of at least one artificial intelligence model by using the generated at least one out-of-distribution inspection data.

According to one or more embodiments of the invention, a system includes: at least one memory; and at least one processor that reads out at least one application stored in the memory and generates out-of-distribution inspection data based on a conditional diffusion model, wherein the instructions of the processor include instructions performing the steps of: loading, by the at least one processor, in-distribution inspection data stored in at least one memory, wherein the inspection data includes multidimensional data obtained by photographing or measuring the state of a target object; inputting, by the at least one processor, the loaded in-distribution inspection data into at least one artificial intelligence model, and obtaining process-based noisy inspection data by noising the in-distribution inspection data up to a specific time-step, wherein the at least one artificial intelligence model includes at least one diffusion model, which is a generative model that learns probability distributions over a predetermined data space to generate data from random noise or to restore original data from noised data; obtaining, by the at least one processor, a semantic mask which is a mask specifying a semantic element for the in-distribution inspection data, and a nuisance mask which is a mask specifying a nuisance element for the in-distribution inspection data, from the noisy inspection data; generating, by the at least one processor, at least one out-of-distribution inspection data by applying selective data processing guidance configured to preserve the nuisance element and modify the semantic element based on the semantic mask and the nuisance mask; and outputting, by the at least one processor, the out-of-distribution inspection data through at least one interface.

The system further includes: a plurality of neurons arranged in an array including at least one register, at least one programmable logic, and at least one input interface; a plurality of synapse circuits storing synapse weights for adjusting connection strengths among the plurality of neurons; and at least one routing network for controlling data flow among the plurality of neurons, wherein each of the plurality of neurons further includes a field programmable gate array (FPGA) configuration connected to at least one other neuron through the routing network to establish a transmission path of the weights.

The system further includes: a plurality of neurons organized in an array including at least one register, at least one microprocessor, and at least one input; and a plurality of synapse circuits storing synapse weights for adjusting connection strengths among the plurality of neurons, wherein each of the plurality of neurons further includes an Application Specific Integrated Circuit (ASIC) for a predetermined artificial neural network, the ASIC being connected to at least one other neuron through any one of the plurality of synapse circuits.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts

FIG. 1 is a block diagram of a computing system that implements a method for generating an abnormal image based on a conditional diffusion model and a method for training an artificial intelligence model on the basis of the same, according to one embodiment of the invention.

FIG. 2 is a block diagram of a computing device that implements a method for generating an abnormal image based on a conditional diffusion model and a method for training an artificial intelligence model on the basis of the same, according to one embodiment of the invention.

FIG. 3 is a block diagram of another aspect of a computing device that implements a method for generating an abnormal image based on a conditional diffusion model and a method for training an artificial intelligence model on the basis of the same, according to one embodiment of the invention.

FIG. 4 is a flowchart for explaining a method for generating an abnormal image based on a conditional diffusion model and a method for training an artificial intelligence model on the basis of the same, according to one embodiment of the invention.

FIG. 5 is a conceptual diagram for explaining a method for generating an abnormal image based on a conditional diffusion model and a method for training an artificial intelligence model on the basis of the same, according to one embodiment of the invention.

FIG. 6 illustrates examples of a semantic mask and a nuisance mask for an original image according to one embodiment of the invention.

FIG. 7 illustrates examples of an original image and a virtual abnormal image according to one embodiment of the invention.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one element's relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

[An Example of the System that Implements a Method for Generating an Abnormal Image Based on a Conditional Diffusion Model and a Method for Training an Artificial Intelligence Model on the Basis of the Same]

As used herein, the term “abnormal image” includes both a real abnormal image and a generated abnormal image (also referred to herein as a “virtual abnormal image”)

Hereinafter, an example of the system that implements a method for generating an abnormal image based on a conditional diffusion model and a method for training an artificial intelligence model on the basis of the same will be described in detail with reference to the accompanying drawings. The system generates an abnormal image whose nuisance elements are similar to those of a normal image and whose semantic elements differ from them, and trains an artificial intelligence model based on the generated abnormal image, particularly a virtual abnormal image.

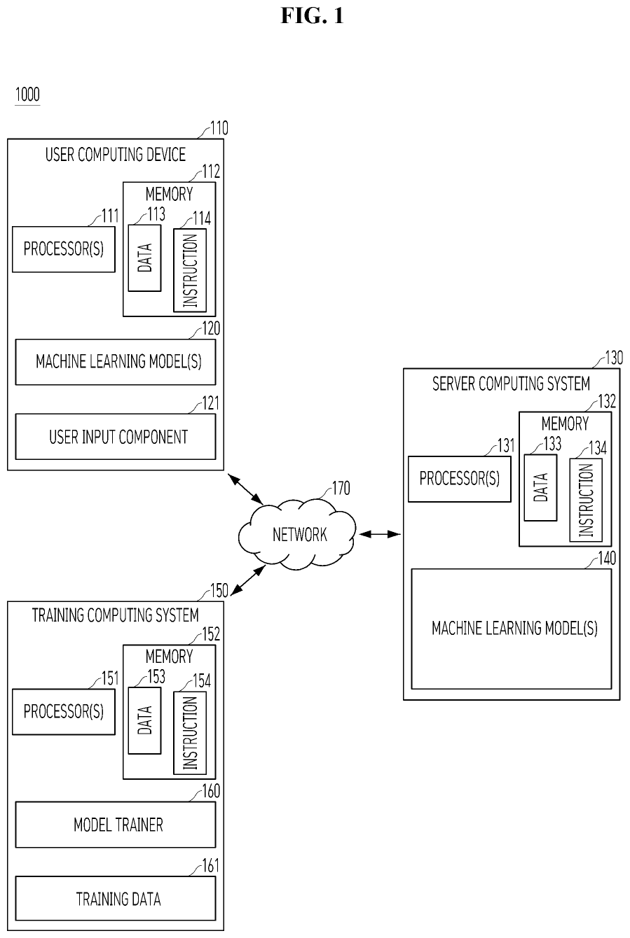

FIG. 1 illustrates an exemplary block diagram of a computing system that implements a method for generating an abnormal image based on a conditional diffusion model and a method for training an artificial intelligence model on the basis of the same, according to one embodiment of the invention.

Referring to FIG. 1, the computing system 1000, which implements a method for generating an abnormal image based on a conditional diffusion model and a method for training an artificial intelligence model on the basis of the same, includes a user computing device 110, a server computing system 130, and a training computing system 150, and each device and system are communicatively connected via a network 170.

The method for generating an abnormal image based on a conditional diffusion model and the method for training an artificial intelligence model on the basis of the same, according to one embodiment of the invention, may be: 1) implemented and provided locally on the user computing device 110, 2) implemented and provided in the form of a web service by the server computing system 130 which communicates with the user computing device 110, or 3) implemented and provided by the user computing device 110 and the server computing system 130 working in conjunction with each other.

In this instance, in the embodiment, the user computing device 110 and/or the server computing system 130 may train a machine learning model 120 and/or 140 through interaction with the training computing system 150 communicatively connected via the network 170. The training computing system 150 may be separate from the server computing system 130 or may be a part of the server computing system 130.

In this case, the artificial intelligence model may be: 1) directly trained locally by the user computing device 110; 2) trained through interaction between the server computing system 130 and the user computing device 110 via the network 170; or 3) trained by the separate training computing system 150 using various training techniques and learning methods. Furthermore, the artificial intelligence model trained by the training computing system 110 may be provided/updated in such a way that it is transmitted to the user computing device 110 and/or the server computing system 130 via the network 170.

In some embodiments, the training computing system 150 may be part of the server computing system 130 or part of the user computing device 110.

### User Computing Device 110

The user computing device 110 may include any type of computing device such as a smart phone, mobile phone, digital broadcasting device, PDA (personal digital assistants), PMP (portable multimedia player), desktop computer, wearable device, embedded computing device, and/or tablet PC.

In some embodiments, the user computing device 110 may further include a predetermined server computing device that provides an environment for abnormal image generation based on a conditional diffusion model and artificial intelligence model training on the basis of the same.

Such a user computing device 110 includes at least one processor 111 and memory 112.

Here, the processor 111 of the user computing device 110 may include at least one of a central processing unit (CPU), graphics processing unit (GPU), ASICs (application specific integrated circuits), DSPs (digital signal processors), DSPDs (digital signal processing devices), PLDs (programmable logic devices), FPGAs (field programmable gate arrays), controllers, micro-controllers, microprocessors, and/or other electrical units for performing functions, or a plurality of electrically connected processors.

In particular, according to certain embodiments, such a processor 111 may be configured based on a field programmable gate array (FPGA) configuration and/or an application specific integrated circuit (ASIC), which are hardware technologies for implementing predefined digital circuits.

As used herein, the field programmable gate array (FPGA) configuration may refer to a flexible digital circuit that can be programmed according to user needs.

In an embodiment, the FPGA implementation may include: registers that temporarily store data, control the flow and timing of signals, and maintain intermediate computational results or state information to support synchronized FPGA operations; programmable logic, which is logic circuits that can be configured according to user needs to program computations within the FPGA so as to perform specific functions or computations within the FPGA according to user needs; and input interfaces, which serve as channels for receiving data from outside the FPGA to receive signals from external devices or sensors and deliver them to internal circuits.

Through the combination of such components, the field programmable gate array configuration may provide flexible and diverse forms of digital circuits.

On the other hand, the application specific integrated circuit (ASIC) may refer to a customized integrated circuit that is designed to perform a specific purpose or function.

For example, the application specific integrated circuit may include: registers, which serve as small memory devices that temporarily store and manage data to store intermediate computational results or state information to support fast processing of ASIC operations; microprocessors, which serve as central processing units that perform control and operations within the ASIC and which, when necessary, perform various computations or generate control signals to coordinate the operation of the overall system; and input blocks, which serve as interfaces for receiving data from external sources, and which receive data as inputs to be processed by the ASIC and deliver it to the inside and receive diverse input data through connections with sensors or external devices.

Through the combination of the above components, an application specific integrated circuit may perform tasks for a particular purpose in an optimized manner.

Returning to the previous topic, the memory 112 of the user computing device 110 may include one or more non-transitory/transitory computer-readable storage media such as RAM, ROM, EEPROM, EPROM, flash memory devices, magnetic disks, etc. and combinations thereof, and may further include web storage of a server that performs memory storage functions over the Internet. Such memory 112 may store data 113 and instructions 114 required for the at least one processor 111 to perform functional operations such as training an artificial intelligence model, generating abnormal images through the artificial intelligence model, and/or executing artificial intelligence model training.

In one embodiment, the user computing device 110 may perform various deep learning operations for a method for generating an abnormal image based on a conditional diffusion model and a method for training an artificial intelligence model on the basis of the same, in conjunction with a deep-learning neural network.

Here, the deep-learning neural network according to the embodiment may include a convolutional neural network (CNN), R-CNN (Regions with CNN features), Fast R-CNN, Faster R-CNN, Mask R-CNN, and any other deep-learning neural network that incorporates an algorithm capable of performing the embodiments described below. The embodiments of the invention do not limit or restrict the deep-learning neural network itself.

In one embodiment, the deep-learning neural network may be directly installed on the server computing system 130, or may operate as a device separate from the server computing system 130 to perform deep learning for the method for generating an abnormal image based on a conditional diffusion model and the method for training an artificial intelligence model on the basis of the same.

Furthermore, in one embodiment, the user computing device 110 may store at least one machine learning model 120.

For example, the user computing device 110 may include various machine learning models such as multiple neural networks (e.g., deep neural networks) that perform the method for generating an abnormal image based on a conditional diffusion model and the method for training an artificial intelligence model on the basis of the same, based on structured/quantitative data, or other types of machine learning models including nonlinear models and/or linear models, or combinations thereof.

As an example, the machine learning models may store linear regression, decision trees, random forests, gradient boosting, pre-trained language models, and/or deep learning models. The neural networks may include at least one of feed-forward neural networks, recurrent neural networks (e.g., long short-term memory recurrent neural networks), convolutional neural networks, and/or other types of neural networks.

In one embodiment, the user computing device 110 may store models to be used in each process and prompt templates that serve as the basis for inputs into the models, in order to perform at least part of the process of performing, through a large language model (LLM), the method for generating an abnormal image based on a conditional diffusion model and the method for training an artificial intelligence model on the basis of the same.

In one embodiment, the user computing device 110 may receive at least one machine learning models 120 from the server computing system 130 via the network 170, store it in the memory 112, and then execute the stored machine learning model 120 by the processor 111 to perform conditional diffusion model-based abnormal image generation and artificial intelligence model training on the basis of the same.

In another embodiment, the user computing device 110 may implement the method for generating an abnormal image based on a conditional diffusion model and the method for training an artificial intelligence model on the basis of the same by performing operations through at least one machine learning model 140 in conjunction with the server computing system 130 and externally communicating related data.

For example, the user computing device 110 may perform the method for generating an abnormal image based on a conditional diffusion model and the method for training an artificial intelligence model on the basis of the same in such a way that the server computing system 130 provides outputs in response to user inputs via the web by using the machine learning models 140.

In addition, artificial intelligence models may be implemented in such a way that at least some of the machine learning models 120 and/or 140 are executed on the user computing device 110, while the rest are executed on the server computing system 130.

Furthermore, the user computing device 110 may include at least one user input component 121 for detecting user input.

For example, the user input component 121 may include a touch sensor (e.g., a touch screen and/or touch pad) that detects touch from the user's input medium (such as a finger or stylus), an image sensor that detects user motion input, a microphone that detects user voice input, buttons, a mouse, and/or a keyboard.

Here, the image sensor may include an image processing module. Specifically, the image sensor may process still images or video obtained by an image sensor device (e.g., CMOS or CCD).

In addition, the image sensor may use an image recognition process (e.g., OCR) and/or an image processing module to process still images or video obtained through the image sensor device, extract necessary information, and deliver the extracted information to the processor.

Furthermore, the input component 121 may receive input from an external controller (e.g., mouse, keyboard, etc.) based on an interface module, and in such cases may include an external output device (e.g., speaker).

In this case, the interface module may be configured to include at least one of a wired/wireless headset port, an external charger port, a wired/wireless data port, a memory card port, a port for connecting a device equipped with an identification module, an audio input/output (I/O) port, a video input/output (I/O) port, an earphone port, a power amplifier, an RF circuit, a transceiver, and other communication circuits.

In addition, the external output device may include a display system that outputs, as graphic images, various information related to the method for generating an abnormal image based on a conditional diffusion model and the method for training an artificial intelligence model on the basis of the same.

Such a display system may be implemented to include at least one of a liquid crystal display (LCD), a thin film transistor-liquid crystal display (TFT LCD), an organic light-emitting diode (OLED), a flexible display, a three-dimensional (3D) display, and an electronic ink (e-ink) display.

Meanwhile, the user computing device 110 including the aforementioned components may additionally perform at least some of the functional operations performed by the server computing system 130.

### Server Computing System 130

The server computing system 130 may perform a series of processes to provide the method for generating an abnormal image based on a conditional diffusion model and the method for training an artificial intelligence model on the basis of the same.

Specifically, in one embodiment, the server computing system 130 may provide the method for generating an abnormal image based on a conditional diffusion model and the method for training an artificial intelligence model on the basis of the same by exchanging necessary data with external devices such as the user computing device 110 so that the conditional diffusion model-based abnormal image generation and the artificial intelligence model training processes on the basis of the same can be executed on those external devices.

In more detail, in one embodiment, the server computing system 130 may provide an environment in which applications can operate on the user computing device 110.

To this end, the server computing system 130 may include application programs, data, and/or instructions required for the operation of applications, and may transmit and receive various data based thereon to and from the external devices. In addition, the server computing system 130 may include at least one processor 131 and memory 132.

Here, the processor 131 of the server computing system 130 may include at least one of a central processing unit (CPU), graphics processing unit (GPU), ASICs (application specific integrated circuits), DSPs (digital signal processors), DSPDs (digital signal processing devices), PLDs (programmable logic devices), FPGAs (field programmable gate arrays), controllers, micro-controllers, microprocessors, and/or other electrical units for performing functions, or a plurality of electrically connected processors. In particular, according to certain embodiments, such a processor 131 may be configured based on a field programmable gate array (FPGA) configuration and/or an application specific integrated circuit (ASIC), which are hardware technologies for implementing predefined digital circuits. Detailed descriptions thereof are omitted as they have been provided in the foregoing explanations of FPGA and ASIC.

The memory 132 may include one or more non-transitory/transitory computer-readable storage media such as RAM, ROM, EEPROM, EPROM, flash memory devices, magnetic disks, and combinations thereof. Such memory 132 may store data 133 and instructions 134 necessary for the processor 131 to perform functional operations such as training an artificial intelligence model or executing conditional diffusion model-based abnormal image generation and artificial intelligence model training on the basis of the same.

In one embodiment, the server computing system 130 may be implemented to include at least one computing device. For example, the server computing system 130 may be implemented to operate multiple computing devices according to a sequential computing architecture, a parallel computing architecture, or a combination thereof. In addition, the server computing system 130 may include multiple computing devices connected via the network 170.

In addition, the server computing system 130 may store at least one machine learning model 140. For example, the server computing system 130 may include, as the machine learning model 140, a neural network and/or others such as a multi-layer nonlinear model. Exemplary neural networks may include feed-forward neural networks, deep neural networks, recurrent neural networks, and convolutional neural networks.

In an embodiment, the server computing system 130 may further include a data store computing system (hereinafter, “data store”) which is a storage location for continuously storing and managing raw data serving as the basis for the method for generating an abnormal image based on a conditional diffusion model and the method for training an artificial intelligence model on the basis of the same.

Such a data store may include various types of data storage locations ranging from file systems to cloud storage. For example, the data store may include at least one database such as a relational database that uses structured query language (SQL) to define and manipulate data, a NoSQL database designed for flexibility and scalability to handle unstructured and semi-structured data, a data warehouse, which is a system used for reporting and data analysis, optimized for queries and analysis by centralizing large volumes of data from multiple sources, a data lakehouse which stores large volumes of raw data in its native format, including structured data, semi-structured data, and unstructured data, and a local storage device or NAS (Network Attached Storage) which store data in files typically accessible by computer operating systems.

### Training Computing System 150

The training computing system 150 includes at least one processor 151 and memory 152.

Here, the processor 151 of the training computing system 150 may include at least one of a central processing unit (CPU), graphics processing unit (GPU), ASICs (application specific integrated circuits), DSPs (digital signal processors), DSPDs (digital signal processing devices), PLDs (programmable logic devices), FPGAs (field programmable gate arrays), controllers, micro-controllers, microprocessors, and/or other electrical units for performing functions, or a plurality of electrically connected processors.

In particular, according to an embodiment, such a processor 151 may be configured based on a field programmable gate array (FPGA) configuration and/or an application specific integrated circuit (ASIC), which are hardware technologies for implementing predefined digital circuits. Detailed descriptions thereof are omitted as they have been provided in the foregoing explanations of FPGA and ASIC.

The memory 152 may include one or more non-transitory/transitory computer-readable storage media such as RAM, ROM, EEPROM, EPROM, flash memory devices, magnetic disks, and combinations thereof. Such memory 152 may store data 153 and instructions 154 necessary for the processor 151 to perform the training of an artificial intelligence model.

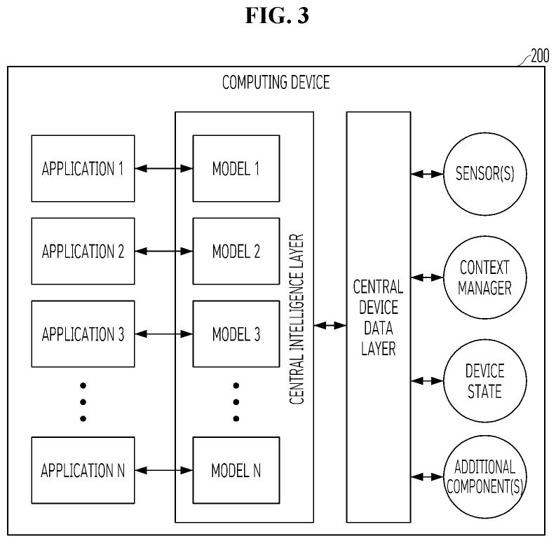

For example, the training computing system 150 may include a model trainer 160 that trains the machine learning models 120 and/or 140 stored in the user computing device 110 and/or the server computing system 130, by using various training or learning techniques such as error backpropagation (according to the framework illustrated in FIG. 3).

By way of example, such a model trainer 160 may update one or more parameters of the machine learning models 120 and/or 140 for the method for generating an abnormal image based on a conditional diffusion model and the method for training an artificial intelligence model on the basis of the same, based on a defined loss function, by using backpropagation.

In some implementations, performing error backpropagation may include performing truncated backpropagation through time. The model trainer 160 may perform multiple regularization techniques (e.g., weight decay, dropout, and/or knowledge distillation) to improve the regularization capability of the machine learning models 120 and/or 140 being trained.

In addition, the model trainer 160 may train the machine learning models 120 and/or 140 based on a series of training data 161. Here, the training data 161 may include different types of data such as images, audio samples, and/or text. Examples of available image types include video frames, LiDAR point clouds, X-ray images, computed tomography (CT) scans, hyperspectral images, and/or various other forms of images.

Such training data 161 may be provided by the user computing device 110 and/or the server computing system 130. When the training computing device trains the machine learning models 120 and/or 140 on specific data of the user computing device 110, the machine learning models 120 and/or 140 may be characterized as personalized models.

In addition, the model trainer 160 includes computer logic utilized to provide desired functions.

In addition, the model trainer 160 may be implemented as hardware, firmware, and/or software that controls a general-purpose processor. In one implementation, the model trainer 160 may include program files stored in a storage device, which are loaded into the memory 152 and executed by one or more processors 151. In another implementation, the model trainer 160 may include one or more sets of computer-executable data 153 and instructions 154 stored in a tangible computer-readable storage medium such as RAM, hard disk, or optical or magnetic media.

The network 170 may include, but is not limited to, a 3rd Generation Partnership Project (3GPP) network, Long Term Evolution (LTE) network, World Interoperability for Microwave Access (WiMAX) network, the Internet, a Local Area Network (LAN), a Wireless Local Area Network (WLAN), a Wide Area Network (WAN), a Personal Area Network (PAN), a Bluetooth network, a satellite broadcasting network, an analog broadcasting network, and/or a Digital Multimedia Broadcasting (DMB) network.

In general, communication via the network 170 may be performed using any type of wired and/or wireless connection, through various communication protocols (e.g., TCP/IP, HTTP, SMTP, and/or FTP), encodings or formats (e.g., HTML and/or XML), and/or protection schemes (e.g., VPN, secure HTTP, and/or SSL).

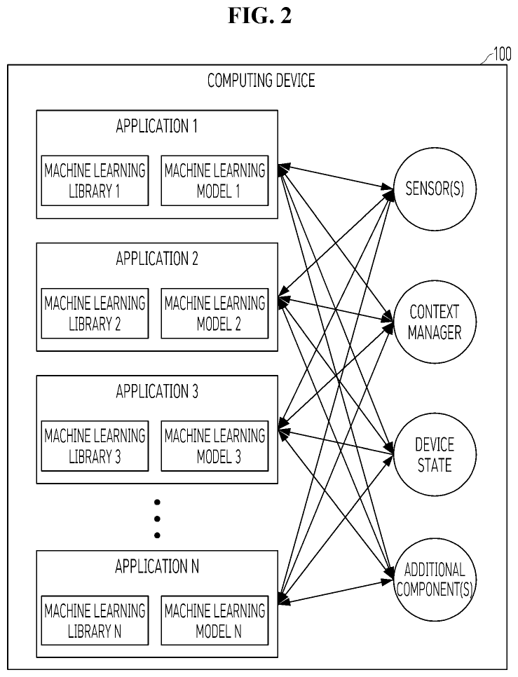

FIG. 2 illustrates an exemplary block diagram of a computing device that implements a method for generating an abnormal image based on a conditional diffusion model and a method for training an artificial intelligence model on the basis of the same, according to one embodiment of the invention.

Referring to FIG. 2, the computing device 100 included in the user computing device 110, the server computing system 130, and the training computing system 150 includes multiple applications (for example, Application 1 through Application N). Each application may include a machine learning library and one or more machine learning models. For instance, the applications may include image processing applications (e.g., detection, classification, and/or segmentation), text messaging applications, email applications, dictation applications, virtual keyboard applications, browser applications, and/or chat-bot applications.

In an embodiment, the computing device 100 may include a model trainer 160 for training an artificial intelligence model, and by storing and operating the trained artificial intelligence model, may provide output data corresponding to predetermined input data (for example, images and/or video).

Each application of the computing device 100 may communicate with various other components of the computing device 100, such as at least one sensor, a context manager, a device state component, and/or additional components. In one embodiment, each application may communicate with each device component using an API (for example, a public API). In one embodiment, the API used by each application may be specific to that application.

FIG. 3 illustrates an exemplary block diagram of another aspect of a computing device that implements a method for generating an abnormal image based on a conditional diffusion model and a method for training an artificial intelligence model on the basis of the same, according to one embodiment of the invention.

Referring to FIG. 3, the computing device 200 includes multiple applications (for example, Application 1 through Application N). Each application may communicate with a central intelligence layer. For example, the applications may include image processing applications, text messaging applications, email applications, dictation applications, virtual keyboard applications, and/or browser applications. In one embodiment, each application may communicate with the central intelligence layer (and the models stored therein) using an API (e.g., a common API shared across all applications).

The central intelligence layer may include multiple machine learning models. For example, as illustrated in FIG. 3, at least some of the machine learning models may be provided for each application and managed by the central intelligence layer. In another implementation, two or more applications may share a single machine learning model. For example, in certain implementations, the central intelligence layer may provide a single model for all applications. In some implementations, the central intelligence layer may be included within the operating system of the computing device 200 or otherwise implemented.

The central intelligence layer may communicate with a central device data layer. The central device data layer may serve as a centralized data repository for the computing device 200. As illustrated in FIG. 3, the central device data layer may communicate with various other components of the computing device 200, such as one or more sensors, a context manager, a device state component, and/or additional components. In some implementations, the central device data layer may communicate with each device component using an API (for example, a private API).

The technology described herein may make reference to servers, databases, software applications, and/or other computer-based systems, as well as actions taken and information sent to and/or from such systems. The inherent flexibility of computer-based systems allows for a great variety of possible configurations, combinations, and/or divisions of tasks and/or functionality between and among components. For example, processes discussed herein can be implemented using a single device or component and/or multiple devices or components working in combination. Databases and/or applications can be implemented on a single system and/or distributed across multiple systems. Distributed components can operate sequentially and/or in parallel.

### [A Method for Generating an Abnormal Image Based on a Conditional Diffusion Model and a Method for Training an Artificial Intelligence Model on the Basis of the Same]

Hereinafter, a method according to one embodiment of the invention will be described in detail with reference to the accompanying drawings, in which the computing system 1000 generates an abnormal image whose nuisance elements are similar to those of a normal image and whose semantic elements differ from them, and trains an artificial intelligence model based on the generated virtual abnormal image.

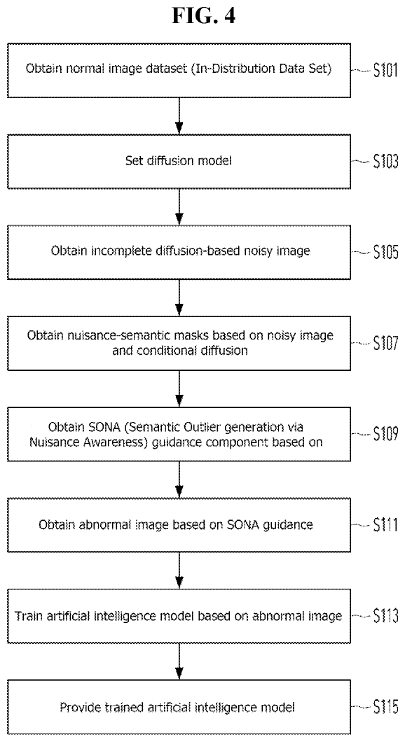

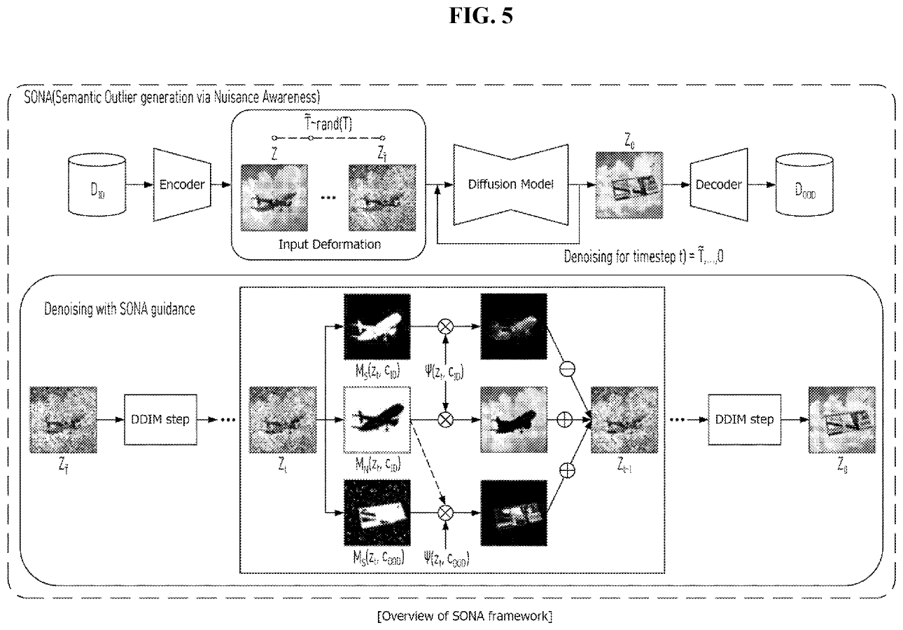

FIG. 4 illustrates a flowchart for explaining a method for generating an abnormal image based on a conditional diffusion model and a method for training an artificial intelligence model on the basis of the same, according to one embodiment of the invention. FIG. 5 illustrates a conceptual diagram for explaining a method for generating an abnormal image based on a conditional diffusion model and a method for training an artificial intelligence model on the basis of the same, according to one embodiment of the invention.

Referring to FIGS. 4 and 5, a method for generating an abnormal image based on a conditional diffusion model and a method for training an artificial intelligence model on the basis of the same, according to one embodiment of the invention, may include: obtaining a normal image dataset (In-Distribution Data Set) (S101); setting a diffusion model (S103); obtaining an incomplete diffusion-based noisy image (S105); obtaining nuisance-semantic masks based on the noisy image and conditional diffusion (S107); configuring a SONA (Semantic Outlier generation via Nuisance Awareness) guidance component based on the nuisance-semantic masks (S109); obtaining an abnormal image based on the SONA guidance (S111); performing artificial intelligence model training based on the abnormal image (S113); and providing the trained artificial intelligence model (S115).

Specifically, the computing system 1000 according to one embodiment of the invention may obtain a normal image dataset (In-Distribution Data Set) (S101).

In detail, in an embodiment, the computing system 1000 may collect and obtain a normal image dataset that corresponds to a particular domain, purpose, and/or environment, in conjunction with a predetermined server and/or user input.

For example, the computing system 1000 may obtain a normal image dataset based on a dataset of normal product images generated in a specific manufacturing process and/or a dataset of specific class images from publicly available standard image datasets (e.g., CIFAR-10 and/or ImageNet).

At this point, in one embodiment, the computing system 1000 may perform labeling corresponding to “normal” for each normal image (In-Distribution data) included in the normal image dataset.

Additionally, according to an embodiment, the computing system 1000 may perform image preprocessing on the obtained normal image dataset.

In an embodiment, the computing system 1000 may perform preprocessing such as normalization, standardization, and/or resolution adjustment for each normal image.

Here, an image according to an embodiment of the invention may include nuisance elements and semantic elements.

Specifically, in an embodiment, the nuisance elements may refer to elements (e.g., background, texture, and/or lighting) that are not directly related to the core meaning of a particular object (e.g., a predetermined item).

In contrast, in an embodiment, the semantic elements may refer to elements that play a key role in image classification or recognition, such as a specific object itself (e.g., a predetermined item).

That is, in an embodiment, an image may include common, non-essential nuisance element information and essential, core semantic element information.

In addition, the computing system 1000 according to one embodiment of the invention may set a diffusion model (S103).

For reference, the term diffusion model refers to a generative model that gradually learns a probability distribution over an entire image (or data) space to generate an image from random noise or, conversely, restore an original image from a noised image.

Generally, such a diffusion model (i) sequentially adds noise to an input image in a forward diffusion stage, and (ii) reconstructs the original image through a learned probabilistic process in a reverse diffusion stage, thereby enabling image synthesis under various conditions (for example, text and/or class labels).

In this instance, according to an embodiment, the diffusion model may perform the above-described reverse diffusion stage using a predetermined method such as DDIM (Deterministic Diffusion Implicit Models).

In detail, in an embodiment, the computing system 1000 may construct a predetermined pre-trained diffusion model.

In an embodiment, the computing system 1000 may construct a diffusion model that is pre-trained so as to be optimized for image generation (e.g., a Stable Diffusion Model, a Latent Diffusion Model), and/or a diffusion model that is fine-tuned or pre-trained for a specific domain.

In the following embodiments, for effective explanation, the diffusion model will be described with reference to a latent diffusion model (LDM), but it is not limited thereto.

In this instance, in one embodiment, the computing system 1000 may load the constructed diffusion model and set the model environment required for operation.

In an embodiment, the computing system 1000 may configure the input format (e.g., text prompts, class labels, and/or other conditions) and output format (e.g., image form and/or latent representations) of the diffusion model.

Additionally, according to an embodiment, the computing system 1000 may configure encoder and decoder modules together to be connected with the diffusion model, thereby enabling the generation and restoration of images within a predetermined latent space.

In addition, according to an embodiment, the computing system 1000 may adjust and set the hyperparameters of the diffusion model (for example, the total number of diffusion steps, the sampling schedule, the guidance scale, etc.) depending on domain-specific characteristics and/or objectives.

Furthermore, the computing system 1000 according to one embodiment of the invention may obtain an incomplete diffusion-based noisy image (S105).

Specifically, in an embodiment, the computing system 1000 may perform an incomplete diffusion process in which each normal image included in a normal image dataset is noised only up to a certain part, using the diffusion model set as described above.

More specifically, in an embodiment, the computing system 1000 may input a predetermined normal image into a diffusion model.

Then, the diffusion model may perform an incomplete diffusion process in which an input normal image is noised only up to a specific time-step.

Through this, the diffusion model may generate an image that has been noised only up to a certain level (hereinafter referred to as a “noisy image”).

The diffusion model may then provide the generated noisy image to the computing system 1000.

Thus, in the embodiment, the computing system 1000 may obtain a noisy image which is an image with a predetermined noise injected therein only up to a certain part.

Accordingly, in the embodiment, the computing system 1000 may obtain a noisy image which is an image with a predetermined noise injected therein.

In a more specific embodiment, the computing system 1000 may input a normal image into an encoder of the diffusion model (in the embodiment, a pre-trained latent diffusion model (LDM), etc.) to obtain a latent representation z₀.

Additionally, in the embodiment, the computing system 1000 may perform a forward diffusion process of the diffusion model only up to a portion of the total diffusion steps T (for example, an arbitrarily determined step \tilde{T}).

Accordingly, the computing system 1000 may obtain a noised latent representation z_{T} after the step \tilde{T} from the initial latent representation z₀.

At this time, in the embodiment, the computing system 1000 may set the aforementioned step \tilde{T} within the range of 1 to T (i.e., 1<=\tilde{T}<=T), either arbitrarily or according to a specific rule, thereby controlling the degree of noising.

Here, the computing system 1000 may obtain a noisy image with a relatively large number of semantic elements preserved from the original normal image since, when \tilde{T} is smaller, less noise is added, and may obtain a noisy image with a relatively small number of semantic elements preserved from the original normal image since, when \tilde{T} is larger, more noise is added.

However, if \tilde{T} is too small, the original normal image remains almost intact, which may reduce subsequent transformation of semantic elements, and if \tilde{T} is too large, the image may become an image that is close to pure random noise, which may reduce subsequent preservation of nuisance elements.

In an embodiment of the invention, since the computing system 1000 aims to generate abnormal images (Out-of-Distribution data) whose nuisance elements are similar to those of a normal image and whose semantic elements differ from them, it may determine \acute{T} optimized for the above-described functional operation according to a predetermined method.

As an example, the computing system 1000 may sample \tilde{T} in a uniform distribution within a certain range between 1 and T. In another example, the computing system 1000 may fixedly use \tilde{T} that is experimentally optimized for a specific domain.

Thus, in the embodiment, the computing system 1000 may perform an incomplete diffusion process in which a normal image is noised only up to a certain part, thereby securing base data for a subsequent diffusion process that is carried out subsequently to modify semantic elements while preserving nuisance elements.

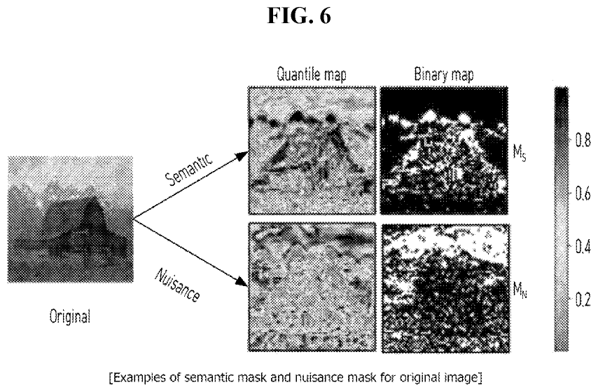

FIG. 6 illustrates examples of a semantic mask and a nuisance mask for an original image according to one embodiment of the invention.

Furthermore, referring to FIG. 6, the computing system 1000 according to one embodiment of the invention may obtain nuisance-semantic masks based on a noisy image and conditional diffusion (S107).

Specifically, in the embodiment, the computing system 1000 may perform predetermined conditional diffusion and unconditional diffusion processes based on the noisy image obtained as described above.

For reference, the term conditional diffusion refers to a method in which, during the denoising (reverse diffusion) process of the diffusion model, a specific “condition” such as a text prompt, class label, and/or style information is provided as input, thereby adjusting the direction of the image (or data) generated through reverse diffusion. In other words, conditional diffusion may be a technique that induces the model not merely to restore noise randomly but to denoise and generate data so as to comply with a given condition.

On the other hand, unconditional diffusion refers to a method in which, during the denoising (reverse diffusion) process of the diffusion model, an image is generated (or restored) under no given external condition such as a text prompt, class label, and/or style information. That is, unconditional diffusion may be a technique of generating or restoring the image by denoising without any additional conditions, based on a data distribution learned by a model.

More specifically, in the embodiment, the computing system 1000 may perform noise prediction on the noisy image according to predetermined conditional diffusion and unconditional diffusion.

Specifically, in the embodiment, the computing system 1000 may calculate a noise prediction value (hereinafter, conditional prediction value ε_{θ}(zₜ,cond)) for the noisy image under a given specific condition (for example, a text prompt and/or a class label).

In addition, in the embodiment, the computing system 1000 may calculate a noise prediction value (hereinafter, unconditional prediction value ε_{θ}(zₜ)) for the noisy image in an unconditional state.

Furthermore, in the embodiment, the computing system 1000 may compute a difference value (hereinafter, noise prediction error ψ(zₜ,cond) between the calculated conditional prediction value ε_{θ}(zₜ,cond) and unconditional prediction value ε_{θ}(zₜ).

This can be expressed mathematically as shown in [Equation 1].

$$ψ ( {z}_{t ,} cond ) = {ε}_{θ} ( {z}_{t ,} cond ) - {ε}_{θ} ( {z}_{t} ) \qquad [ Equation 1 ]$$

Here, in [Equation 1], ε_{θ} denotes the noise prediction function, zₜ denotes the latent representation at step t, and cond denotes a specific condition.

Through this, in the embodiment, the computing system 1000 may estimate which pixels in the noisy image respond sensitively to a specific condition (i.e., semantic element).

Specifically, in the embodiment, the computing system 1000 may determine that the larger the absolute value of the noise prediction error ψ(zₜ,cond), the more the corresponding conditional prediction pixel becomes a pixel that responds sensitively to a given condition (i.e., a pixel that reflects a semantic element to a greater extent).

In other words, the computing system 1000 may decide that, the larger the absolute value of the noise prediction error ψ(zₜ,cond), the more the conditional prediction pixel from which it originates becomes a pixel that induces a large change to a given condition, that is, a pixel that is highly involved in a semantic element (hereinafter, a semantic pixel).

In addition, in the embodiment, the computing system 1000 may obtain a semantic mask and a nuisance mask based on the semantic pixels determined as above.

Here, the semantic mask according to the embodiment may refer to a mask representing a region within a given image that includes pixels (i.e., semantic pixels) that respond sensitively to a specific condition.

That is, in the embodiment, the semantic mask may be a mask indicating a region (hereinafter, semantic region) that includes a semantic element which plays a key role in image classification or recognition, such as a specific object itself (for example, a predetermined item).

In the embodiment, the computing system 1000 may determine a semantic region based on semantic pixels which are pixels for which the absolute value of the noise prediction error ψ(zₜ,cond) belongs to the top N (>0) percent (for example, the top 5%).

The computing system 1000 may then perform masking so as to include the pixels corresponding to the determined semantic region (i.e., semantic pixels).

In the embodiment, the computing system 1000 may generate a binary mask that keeps each semantic pixel in an activated state and perform masking using the same.

For example, the computing system 1000 may implement masking by applying a binary mask in which a mask value corresponding to semantic pixels is set to “1” and a mask value corresponding to other pixels is set to “0.”

Thus, in the embodiment, the computing system 1000 may obtain a semantic mask that identifies and represents pixels that respond sensitively to a specific condition (i.e., semantic pixels).

Meanwhile, the nuisance mask according to the embodiment may refer to a mask representing a region within a given image that includes pixels with low sensitivity to a specific condition (hereinafter, nuisance pixels).

That is, in the embodiment, the nuisance mask may refer to a mask representing a region (hereinafter, a nuisance region) that includes nuisance elements which are not directly related to the core meaning of a specific object (for example, a predetermined item).

In the embodiment, the computing system 1000 may determine a nuisance region based on nuisance pixels for which the absolute value of the noise prediction error ψ(zₜ,cond) belongs to the bottom M (>0) percent (for example, the bottom 5%).

The computing system 1000 may then perform masking so as to include the pixels corresponding to the determined nuisance region (i.e., nuisance pixels).

In this instance, in the embodiment, the computing system 1000 may generate and apply a binary mask that keeps each nuisance pixel in an activated state, thereby performing the above-described masking.

Thus, in the embodiment, the computing system 1000 may obtain a nuisance mask that identifies and represents pixels with low sensitivity to a specific condition (i.e., nuisance pixels).

In the embodiment, the computing system 1000 may generate the semantic mask and the nuisance mask in such a way that they do not overlap each other.

That is, the computing system 1000 may ensure that the semantic mask and the nuisance mask indicate different parts on the image.

Through such masking processes, in the embodiment, the computing system 1000 may clearly separate a nuisance element and a semantic element within the noisy image. Through this, relevant information may be utilized in subsequent processes so that a diffusion process can be implemented with high accuracy to preserve the nuisance element and transform the semantic element.

Additionally, the computing system 1000 according to one embodiment of the invention may configure a SONA (Semantic Outlier generation via Nuisance Awareness) guidance component based on the nuisance-semantic masks (S109).

Here, the SONA guidance according to the embodiment may refer to a technical component that provides a guide to the reverse diffusion process of the diffusion model, based on the semantic mask and nuisance mask described above, so as to selectively transform semantic elements while maximally preserving nuisance elements.

In the embodiment, such SONA guidance may induce the diffusion model to perform differentiated updates for each region during the denoising process, thereby generating abnormal images that comply with specific conditions.

In the embodiment, the SONA guidance component may refer to a SONA guidance structure that includes elements determining the manner in which SONA guidance is applied to each pixel during the reverse diffusion process of the diffusion model (for example, direction and magnitude).

Specifically, in the embodiment, the SONA guidance component may include an original semantic removal component Δ_{ID}, a nuisance information preservation component Δ_{N}, and a new semantic addition component Δ_{OOD}.

In detail, the original semantic removal component according to the embodiment may be a SONA guidance component that gradually removes the original semantic elements by reversely updating the original (normal) condition for the pixels included in the semantic mask.

In an embodiment, the original semantic removal component Δ_{ID} may cause the original semantics to gradually disappear by reversely updating the noise prediction error ψ(zₜ,cond) of the original condition c_{ID} in each semantic pixel within the semantic mask.

Such an original semantic removal component Δ_{ID} can be expressed mathematically as shown in [Equation 2]:

$${Δ}_{ID} = - {M}_{S} ( {z}_{t ,} {c}_{ID} ) * ψ ( {z}_{t ,} {c}_{ID} ) \qquad [ Equation 2 ]$$

Here, in [Equation 2], M_{S}(zₜ,c_{ID}) denotes the semantic mask for the original condition c_{ID}, and ψ(zₜ,c_{ID}) denotes the noise prediction error ψ(zₜ,cond) between the original condition c_{ID} and the unconditional state.

Meanwhile, the nuisance information preservation component ΔN according to the embodiment may be a SONA guidance component that maximally preserves nuisance elements by updating the pixels included in the nuisance mask in a manner that maintains (restores) the original (normal) condition.

This can be expressed mathematically as shown in [Equation 3]:

$${Δ}_{N} = {M}_{N} ( {z}_{t ,} {c}_{ID} ) * ψ ( {z}_{t} , {c}_{ID} ) \qquad [ Equation 3 ]$$

Here, in [Equation 3], M_{N}(zₜ,c_{ID}) denotes the nuisance mask for the original condition c_{ID}.

On the other hand, the new semantic addition component Δ_{OOD} according to the embodiment may be a SONA guidance component that adds an abnormal semantic element (i.e., new semantic element) by updating the pixels included in the semantic mask to reflect a new abnormal condition c_{OOD}.

In this case, in the embodiment, the new semantic addition component Δ_{OOD} may perform updates according to the new abnormal condition c_{OOD} described above, except for a region overlapping with the nuisance mask for the original condition c_{ID}.

Therefore, the new semantic addition component Δ_{OOD} may easily insert new abnormal semantics without damaging (distorting) the existing nuisance elements.

This can be expressed mathematically as shown in [Equation 4]:

$${Δ}_{O O D} = {M}_{S} ( {z}_{t} , {c}_{O O D} ) * ( 1 - {M}_{N} ( {z}_{t} , {c}_{ID} ) ) * ψ ( {z}_{t} , {c}_{OOD} ) \qquad [ Equation 4 ]$$

Here, in [Equation 4], M_{S}(zₜ,c_{OOD}) may denote the new semantic mask according to the abnormal condition c_{OOD}, and ψ(zₜ,c_{OOD}) may denote the noise prediction error ω(zₜ,cond) between the new abnormal condition c_{OOD} and the unconditional state.

In detail, returning to FIG. 4, in the embodiment, the computing system 1000 may configure the above-described SONA guidance component based on the semantic mask and the nuisance mask.

In other words, in the embodiment, the computing system 1000 may configure each of the original semantic removal component Δ_{ID}, the nuisance information preservation component Δ_{N}, and the new semantic addition component Δ_{OOD} each by using the semantic mask and the nuisance mask.

In this instance, in the embodiment, the computing system 1000 may calculate each of the original semantic removal component Δ_{ID}, the nuisance information preservation component Δ_{N}, and the new semantic addition component Δ_{OOD}, thereby determining the manner in which guidance is applied to each pixel (for example, direction and magnitude) when the reverse diffusion process is performed through the diffusion model.

Additionally, in the embodiment, the computing system 1000 may obtain the final SONA guidance component Δ_{SONA} (hereinafter, SONA guidance integration component) by combining the configured SONA guidance components (i.e., the original semantic removal component Δ_{ID}), the nuisance information preservation component Δ_{N}, and the new semantic addition component Δ_{OOD}.

This can be expressed mathematically as shown in [Equation 5]:

$${Δ}_{SONA} = {Δ}_{ID} + {Δ}_{N} + {Δ}_{OOD} \qquad [ Equation 5 ]$$

In addition, the computing system 1000 according to one embodiment of the invention may obtain an abnormal image based on SONA guidance (S111).

Here, the abnormal image according to the embodiment may refer to an image that includes a new semantic element other than the semantic element included in the normal image dataset, or an image that has characteristics semantically distinguishable from the normal image.

That is, in the embodiment, the abnormal image may be an image that deviates from the distribution of normal data through semantic elements that have been changed from the normal image.

In this case, in the embodiment, the abnormal image may be an image that maintains nuisance elements in a way similar to those of a normal image, but not semantic elements.

Specifically, in the embodiment, the computing system 1000 may apply the SONA guidance integration component Δ_{SONA} to the reverse diffusion process of the diffusion model.

More specifically, in this embodiment, the computing system 1000 may apply the SONA guidance integration component Δ_{SONA} to the noise prediction values for each timestep (t=\tilde{T}, [symbol] , . . . , 0) in the reverse diffusion process.

Thus, in the embodiment, the computing system 1000 may cause the diffusion model to perform reverse diffusion in a manner that transforms semantic elements while preserving nuisance elements.

That is, the computing system 1000 may implement a reverse diffusion process in which the original (normal) semantic elements gradually disappear, the new (abnormal) semantic elements gradually emerge, and the original (normal) nuisance elements are preserved to the greatest extent possible, by implementing noise prediction for each time-step to reflect the SONA guidance integration component Δ_{SONA} during the reverse diffusion process.

Additionally, in this embodiment, the computing system 1000 may restore the latent representation z₀ obtained at the final time-step (t=0) of the reverse diffusion process into a pixel image x_{OOD} through the decoder of the diffusion model.

Thus, the computing system 1000 may generate an abnormal image whose nuisance elements are similar to those of a normal image and whose semantic elements differ from them.

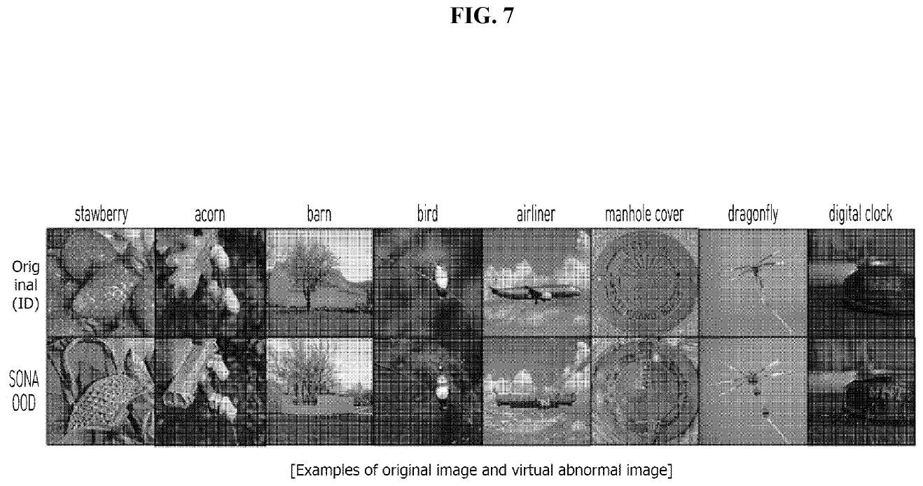

FIG. 7 illustrates examples of an original image and a virtual abnormal image according to one embodiment of the invention.

In this case, referring to FIG. 7, it can be seen that, on a virtual abnormal image generated for each original normal image, the effect of data corruption is observed more directly in a region corresponding to the semantic elements compared to the nuisance elements of the original normal image.

As such, in the embodiment, the computing system 1000 may effectively generate virtual abnormal images that deviate from the distribution of normal data by transforming semantic elements or assigning new abnormal semantics, while maximally preserving nuisance elements such as background, texture, and/or lighting of the normal image.

Through this, in the embodiment, the computing system 1000 may expand the training data of anomaly detection models by utilizing virtual abnormal images even in environments where it is difficult to collect actual abnormal images (OOD data) (for example, in manufacturing processes, medical diagnosis, etc.), thereby saving the cost and time required for this.

Moreover, in the embodiment, the computing system 1000 may provide a guide that clearly distinguishes between a nuisance element and a semantic element based on a normal image and induces data processing (i.e., reverse diffusion) optimized for each of these, thereby directly and significantly improving the reliability and precision of a generated abnormal image.

In particular, in the embodiment, the computing system 1000 may generate high-quality abnormal images even in situations where only normal images exist, and accordingly may easily enhance the anomaly detection performance of models trained on normal data, thereby making it possible to provide models that achieve high performance even in difficult anomaly detection problems such as near-OOD.

Additionally, the computing system 1000 according to one embodiment of the invention may perform artificial intelligence model training based on abnormal images (S113).

Specifically, in the embodiment, the computing system 1000 may train a predetermined artificial intelligence model based on the virtual abnormal image obtained as described above.

In the embodiment, the aforementioned artificial intelligence model may include a predetermined anomaly detection model (e.g., One-Class SVM, Isolation Forest, Autoencoder-based models, etc.) and/or deep learning classifiers (e.g., CNN (Convolutional Neural Network), Transformer-based models, etc.).

More specifically, in the embodiment, the computing system 1000 may generate a training dataset (hereinafter, integrated training dataset) that integrates the existing normal image with the virtual abnormal image, by labeling the abnormal image as “abnormal” and the normal image as “normal”.

In addition, in the embodiment, the computing system 1000 may train a predetermined artificial intelligence model using the integrated training dataset.

As an example, the computing system 1000 may build a model that classifies normal and abnormal data or detects abnormal data by performing model training based on the integrated training dataset.

Furthermore, in one embodiment of the invention, the computing system 1000 may provide the trained artificial intelligence model (S115).

Specifically, in the embodiment, the computing system 1000 may provide the above trained artificial intelligence model in a predetermined manner.

As an embodiment, the computing system 1000 may provide an artificial intelligence model trained on virtual abnormal images, according to the embodiment of the invention, by interoperating with a predetermined application service.

For example, the computing system 1000 may provide the above-described artificial intelligence model by integrating it with various application services such as manufacturing process monitoring systems, medical diagnostic systems, security detection systems, and/or autonomous vehicle systems.

As such, in the embodiment, the computing system 1000 may generate virtual abnormal images whose nuisance elements are maximally preserved and whose semantic elements are transformed, that is, those that are close to the existing normal data distribution (In-Distribution, ID) yet distinctly different therefrom, based on incomplete diffusion, conditional/unconditional diffusion, and SONA guidance strategies, and, based on this, may support model training.

Accordingly, the computing system 1000 may generate high-quality abnormal data even in environments where abnormal data is scarce or difficult to obtain, and utilize it for training artificial intelligence models, thereby dramatically enhancing model performance (e.g., anomaly detection and/or Out-Of-Distribution (OOD) performance).

Moreover, the computing system 1000 may therefore provide high-performance artificial intelligence solutions applicable to various domains such as manufacturing, healthcare, security, and/or autonomous driving, thereby supporting the multifaceted construction of robust systems capable of identifying and responding to potential risks in advance.

Furthermore, the computing system 1000 may therefore reduce the cost and time required for collecting actual abnormal data while also supporting the construction of artificial intelligence models that can flexibly respond to various abnormal situations using only normal data, thereby providing a data-driven solution framework that combines both efficiency and reliability.

The embodiments of the invention described above may be implemented in the form of program instructions that can be executed through various computer components and recorded on computer-readable storage media. The computer-readable storage media may include program instructions, data files, data structures, either alone or in combination. The program instructions recorded on the computer-readable storage media may be specially designed and configured for the embodiments of the invention, or may be those known and available to those skilled in the field of computer software. Examples of the computer-readable storage media include magnetic media such as hard disks, floppy disks, and magnetic tapes; optical recording media such as CD-ROMs and DVDs; magneto-optical media such as floptical disks; and hardware devices specially configured to store and execute program instructions, such as ROM, RAM, and flash memory. Examples of the program instructions include machine code generated by compilers as well as high-level language code that can be executed by a computer using interpreters or the like. The hardware devices may be modified into one or more software modules to perform a process according to the inventive concept, and vice versa.

Particular implementations described herein are merely embodiments, and do not limit the scope of the embodiments of the invention in any way. For the sake of conciseness, descriptions of conventional electronic configurations, control systems, software, and other functional aspects of the systems may be omitted. In addition, the connections or connection members of the lines between the elements illustrated in the drawings are exemplarily illustrative of functional connections and/or physical or circuit connections, and may be alternatively or additionally represented as various functional connections, physical connections, or circuit connections in actual devices. Also, no element may be essential to the practice of the embodiments of the invention unless the element is specifically described as “essential” or “critical”. A method for generating an abnormal image based on a conditional diffusion model and a method and system for training an artificial intelligence model on the basis of the same, according to one embodiment of the invention, have the effect of expanding training data for anomaly detection models by using virtual abnormal images even in environments where it is difficult to collect actual abnormal images (i.e., OOD data), by generating an abnormal image whose nuisance elements are similar to those of a normal image and whose semantic elements differ from them.

Therefore, a method for generating an abnormal image based on a conditional diffusion model and a method and system for training an artificial intelligence model on the basis of the same, according to one embodiment of the invention, have the effect of reducing the cost and time required to build training data and providing models that achieve high performance even in difficult anomaly detection problems such as near-OOD by easily enhancing the anomaly detection performance of models trained on normal data by generating high-quality abnormal images, even in situations where only normal images exist.

In this instance, a method for generating an abnormal image based on a conditional diffusion model and a method and system for training an artificial intelligence model on the basis of the same, according to one embodiment of the invention, have the effect of providing a guide that clearly distinguishes between a nuisance element and a semantic element based on a normal image and induces data processing (i.e., reverse diffusion) optimized for each of these, thereby directly and significantly improving the reliability and precision of a generated abnormal image.

In addition, a method for generating an abnormal image based on a conditional diffusion model and a method and system for training an artificial intelligence model on the basis of the same, according to one embodiment of the invention, have the effect of training an artificial intelligence model based on a generated virtual abnormal image, so that model training using high-quality abnormal data is implemented even in environments where abnormal data is scarce or difficult to obtain, thereby significantly improving model performance (for example, anomaly detection and/or Out-of-Distribution (OOD) performance).

Accordingly, a method for generating an abnormal image based on a conditional diffusion model and a method and system for training an artificial intelligence model on the basis of the same, according to one embodiment of the invention, have the effect of providing high-performance artificial intelligence solutions applicable to various domains such as manufacturing, healthcare, security, and/or autonomous driving, thereby supporting multifaceted construction of robust systems that can identify and respond to potential risk factors in advance.

Furthermore, a method for generating an abnormal image based on a conditional diffusion model and a method and system for training an artificial intelligence model on the basis of the same, according to one embodiment of the invention, have the effect of reducing the cost and time required for collecting actual abnormal data, while also supporting the construction of artificial intelligence models that can flexibly respond to various abnormal situations using only normal data, thereby providing a data-driven solution framework that has both efficiency and reliability.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A method executed by a computer, the method comprising:
loading, by at least one processor of the computer, in-distribution inspection data stored in at least one memory, wherein the inspection data includes multidimensional data obtained by photographing or measuring the state of a target object;
inputting, by the at least one processor, the loaded in-distribution inspection data into at least one artificial intelligence model, and obtaining process-based noisy inspection data by noising the in-distribution inspection data up to a specific time-step, wherein the at least one artificial intelligence model includes at least one diffusion model, which is a generative model that learns probability distributions over a predetermined data space to generate data from random noise or to restore original data from noised data;
obtaining, by the at least one processor, a semantic mask which is a mask specifying a semantic element for the in-distribution inspection data, and a nuisance mask which is a mask specifying a nuisance element for the in-distribution inspection data, from the noisy inspection data;
generating, by the at least one processor, out-of-distribution inspection data by applying selective data processing guidance configured to preserve the nuisance element and modify the semantic element based on the semantic mask and the nuisance mask; and
outputting, by the at least one processor, the out-of-distribution inspection data through at least one interface.

2. The method of claim 1, wherein the step of obtaining noisy inspection data includes injecting the noise into the in-distribution inspection data up to the specific time-step.

3. The method of claim 1, wherein the step of obtaining a semantic mask and a nuisance mask includes performing conditional diffusion to execute a reverse diffusion process according to a specific condition based on the noisy inspection data.

4. The method of claim 3, wherein the step of obtaining a semantic mask and a nuisance mask further includes performing unconditional diffusion to execute the reverse diffusion process unconditionally based on the noisy inspection data.

5. The method of claim 4, wherein the step of obtaining a semantic mask and a nuisance mask further includes calculating a conditional prediction value, which is a noise prediction value according to the conditional diffusion, and an unconditional prediction value, which is a noise prediction value according to the unconditional diffusion.

6. The method of claim 5, wherein the step of obtaining a semantic mask and a nuisance mask further includes calculating a noise prediction error, which is the difference between the conditional prediction value and the unconditional prediction value.

7. The method of claim 6, wherein the step of obtaining a semantic mask and a nuisance mask further includes generating the semantic mask based on pixels for which the absolute value of the noise prediction error belongs to a predetermined top N (>0) percent, and generating the nuisance mask based on pixels for which the absolute value of the noise prediction error belongs to a predetermined bottom M (>0) percent.

8. The method of claim 1, wherein the step of generating out-of-distribution inspection data by applying the selective data processing guidance includes configuring a selective data processing guidance component, which is a component that specifies the manner of applying the selective data processing guidance to the reverse diffusion process of the at least one artificial intelligence model.

9. The method of claim 8, wherein the selective data processing guidance component includes an original semantic removal component, which is a component that gradually removes the semantic element, a nuisance information preservation component, which is a component that preserves the nuisance element, and a new semantic addition component, which is a component that adds a new semantic element.

10. The method of claim 9, wherein the new semantic addition component adds the new semantic element to a region except a region overlapping with the nuisance mask.

11. The method of claim 9, wherein the step of configuring a selective data processing guidance component includes obtaining a selective data processing guidance integration component, which is a component that combines the original semantic removal component, the nuisance information preservation component, and the new semantic addition component into a single component.

12. The method of claim 11, wherein the step of generating out-of-distribution inspection data by applying the selective data processing guidance further includes applying the selective data processing guidance integration component to the noise prediction value for each time-step in the reverse diffusion process.

13. The method of claim 1, further comprising performing, by the at least one processor, training of at least one artificial intelligence model by using the generated at least one out-of-distribution inspection data.

14. A system comprising:
at least one memory; and
at least one processor that reads out at least one application stored in the memory and generates out-of-distribution inspection data based on a conditional diffusion model,
wherein the instructions of the processor include instructions performing the steps of:
loading, by the at least one processor, in-distribution inspection data stored in at least one memory, wherein the inspection data includes multidimensional data obtained by photographing or measuring the state of a target object;
inputting, by the at least one processor, the loaded in-distribution inspection data into at least one artificial intelligence model, and obtaining process-based noisy inspection data by noising the in-distribution inspection data up to a specific time-step, wherein the at least one artificial intelligence model includes at least one diffusion model, which is a generative model that learns probability distributions over a predetermined data space to generate data from random noise or to restore original data from noised data;
obtaining, by the at least one processor, a semantic mask which is a mask specifying a semantic element for the in-distribution inspection data, and a nuisance mask which is a mask specifying a nuisance element for the in-distribution inspection data, from the noisy inspection data;
generating, by the at least one processor, at least one out-of-distribution inspection data by applying selective data processing guidance configured to preserve the nuisance element and modify the semantic element based on the semantic mask and the nuisance mask; and
outputting, by the at least one processor, the out-of-distribution inspection data through at least one interface.

15. The system of claim 14, further comprising:
a plurality of neurons arranged in an array including at least one register, at least one programmable logic, and at least one input interface;
a plurality of synapse circuits storing synapse weights for adjusting connection strengths among the plurality of neurons; and
at least one routing network for controlling data flow among the plurality of neurons,
wherein each of the plurality of neurons further includes a field programmable gate array (FPGA) configuration connected to at least one other neuron through the routing network to establish a transmission path of the weights.

16. The system of claim 14, further comprising:
a plurality of neurons organized in an array including at least one register, at least one microprocessor, and at least one input; and
a plurality of synapse circuits storing synapse weights for adjusting connection strengths among the plurality of neurons,
wherein each of the plurality of neurons further includes an Application Specific Integrated Circuit (ASIC) for a predetermined artificial neural network, the ASIC being connected to at least one other neuron through any one of the plurality of synapse circuits.
